(19) United States
(12) Patent Application Publication
(10) Pub. No.: US 2019/0153882 A1
(43) Pub. Date: May 23, 2019

(54) Turbine Guide Apparatus

(71) Applicant: MAN ENERGY SOLUTIONS SE, Augsburg (DE)

(72) Inventors: Bernd HAAS, Neusass (DE); Johannes NIEBUHR, Augsburg (DE); Harald DENKEL, Baar (DE)

(73) Assignee: MAN ENERGY SOLUTIONS SE

(21) Appl. No.: 16/191,150

(22) Filed: Nov. 14, 2018

(30) Foreign Application Priority Data
Nov. 22, 2017 (DE) 102017127615.7

(51) Int. Cl. F01D 9/04; F04D 29/44

(52) U.S. Cl. CPC F01D 9/045; F02C 6/12; F04D 29/444; F01D 9/041

(57) ABSTRACT

A turbine guide apparatus for a radial turbocharger that is assembled in multiple parts from a first annular disc element, a second annular disc element, and a multiplicity of guide blades, which are arranged between the first and second annular disc element. The guide blades are connected to each annular disc element in a firmly bonded, and/or non-positive, and/or positive manner.

### BACKGROUND OF THE INVENTION

### 1. Field of the Invention

The invention relates to a turbine guide apparatus, in particular a turbine guide apparatus for a radial turbocharger. The preferred field of application of the present invention relates to radial turbocompressors or radial turbochargers. In principle, the application of the invention is also conceivable for other compressors or for turbines.

### 2. Description of the Related Art

In a turbine, fluids generally flow out of one or more chambers through a transition piece and along an intended fluid path. A number of turbine stages can typically be arranged in a row along the fluid path so that the fluids flow through so-called guide apparatuses and blades of a first stage and subsequently through guide apparatuses and blades of following stages of the turbine. In this way, the turbine guide apparatuses can direct the fluids in the direction of the respective blades, as a result of which the blades are induced to rotate and for example drive a consumer, for example an electric generator or the like.

Most of the compressors used today on turbochargers are radial compressors consisting of a radial compressor wheel, a volute housing with rear wall and a diffuser. The air is axially drawn in through the rotation of the compressor wheel and accelerated to high velocities. The air accelerated thus leaves the compressor wheel radially in the direction of the diffuser. Radial turbocompressors are generally used for promoting a process fluid to a higher pressure or a higher density. Here, the process fluid is regularly compressible in nature so that a volume contraction takes place during the compression process.

However since, dependent on the application, it is necessary to suitably adapt the guide apparatuses regarding their dimension, shape and configuration to the application, a high product variance and parts variety materialise. Because of the required variance in blade height and blade profile in the case of turbine guide apparatuses, the production costs of guide apparatuses that are for example cast or produced or milled from solid material are consequently very high because of the many required casting models or the high torsion of machining.

### SUMMARY OF THE INVENTION

It is therefore an object of one aspect of the present invention to overcome said disadvantages and propose a guide apparatus, which despite high shape variance, is cost-effectively producible, provides a high efficiency, and has high operational stability.

In connection with aspects of the invention, terms such axial, tangential, radial or circumferential direction always refer to a rotor axis of the radial turbomachine unless otherwise stated.

A basic idea of one aspect of the invention is that the turbine guide apparatus is assembled in multiple parts from three assemblies, namely a first annular disc element, a second annular disc element, and a multiplicity of guide blades, which are arranged between the first and second annular disc element.

According to the invention, a guide apparatus, in particular a turbine guide apparatus for a radial turbocharger is therefore proposed, wherein the turbine guide apparatus is assembled in multiple parts from a first annular disc element, a second annular disc element and a multiplicity of guide blades, which are arranged between the first and second annular disc element, and wherein the ends of the guide blades are connected to each annular disc element in a firmly bonded and/or in a non-positive and/or positive manner.

Accordingly, a “covered” guide apparatus is obtained. A turbine guide apparatus with covered guide blades makes possible, on the one hand, a higher efficiency since gap losses at the blade tips are avoided and on the other hand, negative influences of rounding radii on the blade roots are avoided. Because of the stiffer structure and the higher resistance during bursting of the turbine wheel, such a turbine guide apparatus can, furthermore, remove more energy than a “non-covered” or cast guide apparatus and thus offers an additional function as burst protection.

In an advantageous configuration of the invention it is provided that the annular disc elements are formed from a material other than the material of the guide blades, preferentially from a more ductile material. According to one aspect of the invention there is thus the possibility of suitably combining different materials and their properties. For example the choice of a ductile material for the annular disc elements and choice of a resistant material for the blades, in order to reduce erosions.

Further advantageous is a configuration in which the annular disc elements comprise suitably formed recesses for fastening the guide blades. The guide blades can, with their respective end sections, be inserted into the corresponding recesses in the annular disc elements or be introduced therein.

In a further advantageous embodiment of the invention it is provided that the two annular disc elements are aligned in parallel planes to one another and the guide blades extend in parallel alignment between the two annular disc elements along their extension axis. In this way, the extension axis also runs parallel to the axis of the turbine guide apparatus.

It is further advantageous when the shape of the respective recess in the annular disc element corresponds to the cross-sectional shape of that guide blade in that region of the guide blade, which projects into this recess. It is particularly advantageous when the form of recess and guide blade end are each correspondingly matched to one another so that on inserting or mounting the ends of the guide blades in the recesses, a positive and non-positive connection between the respective guide blade and the respective annular disc element is established. Alternatively or complementarily however a method for forming a firmly bonded connection can also be selected.

In a likewise advantageous embodiment of the invention it is provided that all guide blades have the same shape, which furthermore has a favourable effect on the assembly and manufacturing costs.

Furthermore, it has proved to be particularly favourable when all guide blades run linearly in the direction of their extension axis and thus without curvature in this direction. Then, the guide blades, because of their shape, can be cost-effectively produced from bar material through die casting or milling and be cut to length depending on the required blade length.

It is advantageously provided, furthermore, that each annular disc element substantially has a thickness that remains the same over the entire circumference and, furthermore the depth of the respective recesses in the annular disc elements amounts to between 50% and 100% of the thickness of the respective annular disc element. With a depth of 100% this means that the recess is formed along the entire thickness as a continuous aperture in the annular element.

It is advantageous, furthermore, when the thickness of the two annular disc elements differs and the thickness of the first annular disc element preferentially amounts to approximately twice the thickness, further preferentially amounts to 175% -225% of the thickness of the second annular disc element. Combined with the abovementioned different material choice it is possible in this way to optimise the technical properties of the turbine guide apparatus.

A further aspect of the present invention relates to a method for producing a turbine guide apparatus as described above with the steps:
a. providing a first and a second annular disc element;
b. providing a number N of guide blades identical in shape;
c. introducing in each case N recesses into each annular disc element corresponding to the cross-sectional shape of the guide blades in their end sections in such positions that the guide blades with their extension direction in parallel alignment can be inserted with their end sections into the recesses of the respective annular disc elements arranged in parallel planes;
d. introducing the guide blades with their respective first end section into the recesses in the first annular disc element;
e. introducing the guide blades with their respective second end section into the recesses in the second annular element; and
f. establishing a positive connection, non-positive connection and/or firmly bonded connection of the guide blades with the respective annular disc elements in the region of the recesses.

The method can be particularly advantageously configured when the N guide blades that are identical in shape are produced from a linearly extending profile by cutting the profile to a suitable length. Alternatively, producing by means of die casting would also be conceivable.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Other advantageous further developments of the invention are characterized in the subclaims or are presented in more detail in the following together with the description of the preferred embodiment of the invention by way of the figures. It shows:

FIG. 1 is a perspective view of an exemplary embodiment of a turbine guide apparatus;

FIG. 2 is a plan view of the first annular disc element of the turbine guide apparatus from FIG. 1;

FIG. 3 is a sectional view along the section line S1-S1 in the FIG. 2;

FIG. 4 a plan view of the second annular disc element of the turbine guide apparatus from FIG. 1;

FIG. 5 is a sectional view along the section line S1-S1 in the FIG. 4; and

FIG. 6 is a view of a front end and next to it of a lateral edge of a guide blade.

### DETAILED DESCRIPTION OF THE PRESENTLY PREFERRED EMBODIMENTS

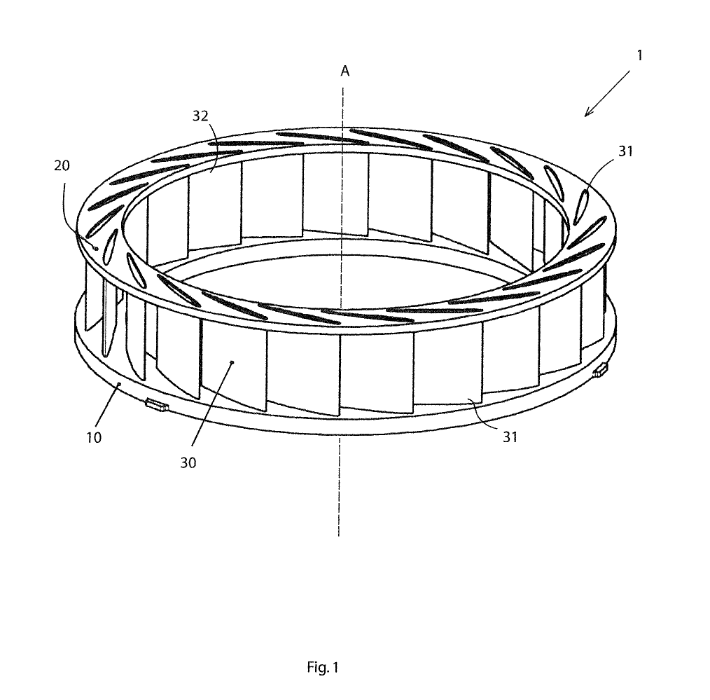

In the following, the invention is described in more detail by way of an exemplary embodiment making reference to the FIGS. 1 to 6, wherein same reference numbers refer to same structural and/or functional features.

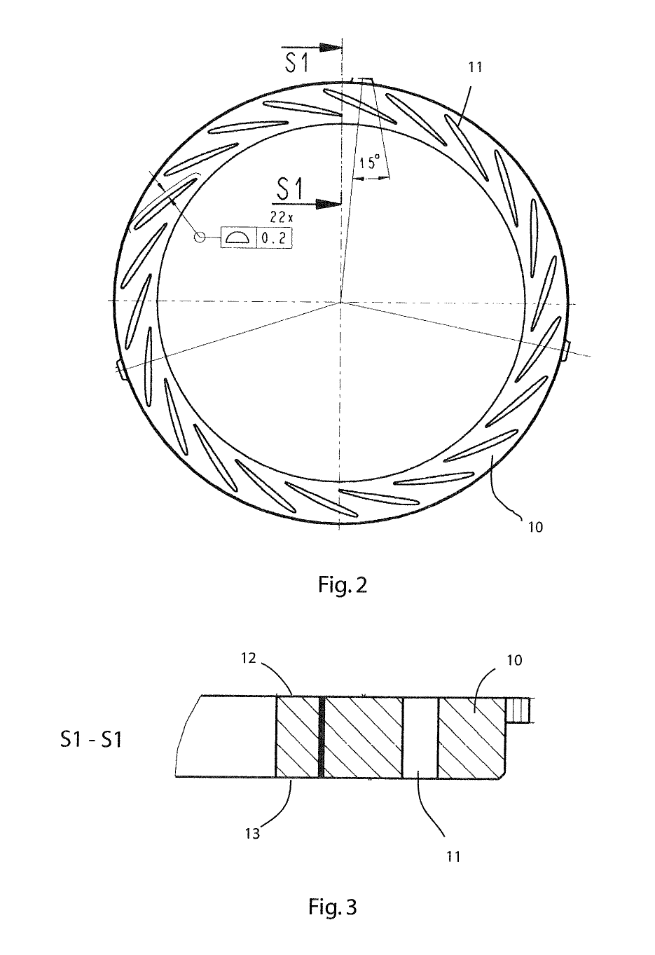

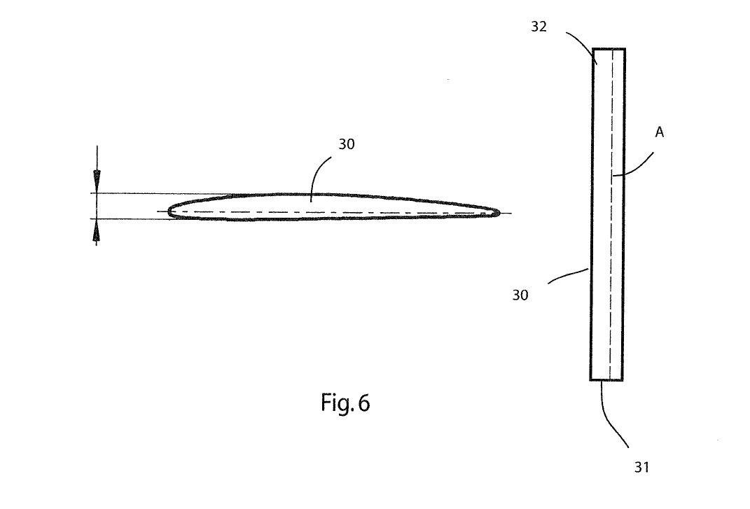

In FIG. 1, a perspective view of an exemplary embodiment of a turbine guide apparatus 1 is shown. The turbine guide apparatus 1 is assembled in multiple parts from the following components: a first annular disc element 10 (as shown in more detail in FIG. 2), a second annular disc element 20 (as shown in more detail in FIG. 4), and a multiplicity of guide blades 30, which are described in more detail with reference to FIG. 6.

The guide blades 30 are arranged between the first and second annular disc element 10, 20, wherein the guide blades 30 are connected to each annular disc element 10, 20 in this exemplary embodiment in a non-positive and positive manner, in that the same are inserted into the pocket-like recesses 11 and 21 respectively in the two annular disc elements 20, 30. The shape of the respective recess 11, 21 of the cross-sectional shape of the guide blade 30 corresponds, for this purpose, to the cross-sectional shape of the respective recess 11 and 21 respectively in the connecting region, which, here, corresponds to the end section 31 and 32 respectively of the guide blade 30. In this exemplary embodiment, all guide blades 30 have the same shape.

The arrangement is configured such that the two annular disc elements 10, 20 are aligned in parallel planes relative to one another and the guide blades 30 extend in the parallel alignment between the two annular element discs 10, 20 along their extension axis A.

In FIGS. 2 and 4, the two annular disc elements 10, 20 are shown in more detail. The two annular disc elements are formed as closed flat and round rings, each with a top side 12 and 22 respectively and each with a bottom side 13 and 32 respectively. The annular disc elements each comprise recesses 11 and 21 respectively for fastening the guide blades 30.

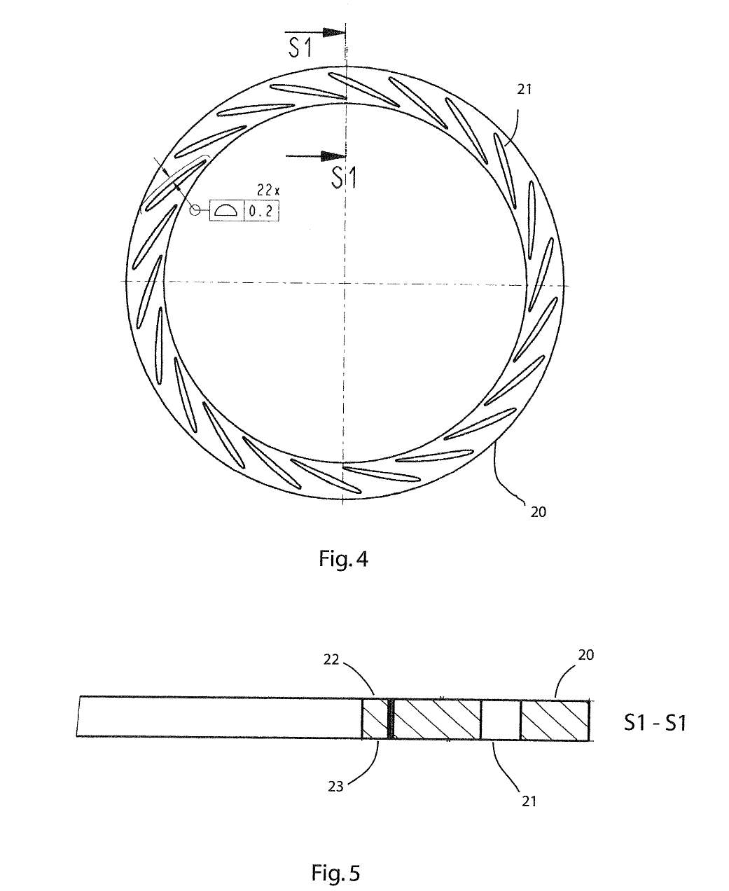

Each annular disc element 10, 20 comprises a number of such recesses 11 and 21 respectively, which extend over the entire thickness of the respective annular disc elements 10, 20, which is evident in the sectional views of the FIGS. 3 and 5. It is mentioned, at this point, that the number of the recesses can be 22 or a number other than 22. The first annular disc element 10 has twice the thickness compared with the second annular disc element 20.

In this embodiment, the guide blades 30 all have the same shape and are introduced with their respective end sections 31, 32 into the corresponding recesses 11, 21 in the annular disc elements 10, 20. In order to influence the efficiency or the oscillation behaviour of the guide blades it is likewise provided in terms of the invention that the guide blades have different shapes and/or designs. FIG. 6 show a view of a front end of an end section 31 and next to it a lateral view of the guide blade 30. It is clearly evident that the guide blade 30 runs in the direction of its extension axis A linearly and thus without curvature in this direction. Extension axis A.

In its embodiment, the invention is not restricted to the preferred exemplary embodiments stated above. On the contrary, a number of versions is conceivable which makes use of the shown solution even with embodiments that are fundamentally different in nature.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A turbine guide apparatus for a radial turbocharger that is assembled in multiple parts, comprising:
a first annular disc element;
a second annular disc element; and
a multiplicity of guide blades, which are arranged between the first annular disc element and the second annular disc element,
wherein each of the multiplicity of guide blades are connected to the first annular disc element and the second annular disc element in a firmly bonded and/or non-positive and/or positive manner.

2. The turbine guide apparatus according to claim 1, wherein the first annular disc element and the second annular disc element are formed from a first material other than a second material of the multiplicity of guide blades.

3. The turbine guide apparatus according to claim 1, wherein
the first annular disc element and the second annular disc element comprise recesses for fastening the multiplicity of guide blades; and
the multiplicity of guide blades, with their respective end sections, are attached in the corresponding recesses in the first annular disc element and the second annular disc element.

4. The turbine guide apparatus according to claim 1, wherein the first annular disc element and the second annular disc element are aligned in parallel planes relative to one another and the multiplicity of guide blades extend in parallel alignment between the first annular disc element and the second annular disc element along their extension axis.

5. The turbine guide apparatus according to claims 2, wherein a shape of a respective recess corresponds to a cross-sectional shape of that guide blade in that region of the guide blade which projects into the corresponding recess.

6. The turbine guide apparatus according to claim 1, wherein each of the multiplicity of guide blades have a same shape.

7. The turbine guide apparatus according to claim 1, wherein each of the multiplicity of guide blades run linearly in a direction of their respective extension axis and thus without curvature in this direction.

8. The turbine guide apparatus according to claim 2, wherein
each of the first annular disc element and the second annular disc element has a thickness that remains substantially constant over an entire circumference; and
a depth of the respective recesses in the first annular disc element and the second annular disc element amounts to between 50% and 100% of the thickness of a respective annular disc element.

9. The turbine guide apparatus according to claim 8, wherein
the thickness of the first annular disc element and the thickness the second annular disc element differs; and
the thickness of the first annular disc element amounts to approximately twice the thickness.

10. A method for producing a turbine guide apparatus that is assembled in multiple parts, comprising:
a. providing a first and a second annular disc element;
b. providing a number N of guide blades that are identical in shape;
c. introducing in each case N recesses into each of the first annular disc element and the second annular disc element corresponding to a cross-sectional shape of the guide blades in their end sections in such positions that the guide blades with their extension direction in parallel alignment can be inserted with their end sections into the recesses of the respective annular disc elements that are arranged in parallel planes;
d. introducing the guide blades with their respective first end section into the recesses in the first annular disc element;
e. introducing the guide blades with their respective second end section into the recesses in the second annular disc element; and
f. establishing a positive connection, non-positive connection, and/or firmly bonded connection of the guide blades with the respective annular disc elements in the region of the recesses.

11. The method according to claim 10, wherein the N guide blades that are identical in shape are produced from a linearly extending profile by cutting a profile to a suitable length.

12. The method according to claim 10, wherein N is 22.

13. The turbine guide apparatus according to claim 2, wherein the first material is more ductile than the second material.

14. The turbine guide apparatus according to claim 8, wherein
the thickness of the first annular disc element and the thickness the second annular disc element differs; and
the thickness of the first annular disc element amounts to approximately 175%-225% of the thickness of the second annular disc element.
